(19) United States
(12) Patent Application Publication
(10) Pub. No.: US 2025/0165794 A1
(43) Pub. Date: May 22, 2025

(54) SYSTEMS AND METHODS FOR INVERSE CONSTRAINT REINFORCEMENT FROM A MIXTURE OF EXPERTS

(71) Applicants: Guiliang LIU, Shenzhen (CN); Pascal POUPART, Kitchener (CA); Huawei Technologies Canada Co., Ltd., Kanata (CA)

(72) Inventors: Guiliang LIU, Shenzhen (CN); Pascal POUPART, Kitchener (CA); Mohammed ELMAHGIUBI, Richmond Hill (CA); Kasra REZAEE, Kitchener (CA)

(21) Appl. No.: 18/512,619

(22) Filed: Nov. 17, 2023

(51) Int. Cl. G06N 3/092

(52) U.S. Cl. CPC G06N 3/092

(57) ABSTRACT

Methods and processors for inferring constraints for reinforcement learning of an Artificial Intelligence (AI) model for subsequent deployment of that AI model in an environment. The method includes accessing a set of expert trajectories, each expert trajectory comprising a sequence of expert state-action pairs, a given one of the sequences of the expert state-action pairs including information about a given state of the environment and a corresponding action that is to be executed in response to the given state, partitioning the set of expert trajectories into one or more subsets of expert trajectories by employing a trained neural network, each subset being associated with one of the agents and determining, for each agent, an agent constraint based on the corresponding subset of expert trajectories.

### FIELD

The present technology relates generally to neural networks; and in particular, to systems and methods for inferring constraints for reinforcement learning of an Artificial Intelligence (AI) model for subsequent deployment of that AI model in an environment.

### BACKGROUND

In a reinforcement learning system, an agent interacts with an environment by receiving an observation that either fully or partially characterizes the current state of the environment, and in response, performing an action selected from a predetermined set of actions. The reinforcement learning system receives rewards from the environment in response to the agent performing actions and selects the action to be performed by the agent in response to receiving a given observation in accordance with an output of a value function representation. The value function representation takes as an input an observation and an action and outputs a numerical value that is an estimate of the expected rewards resulting from the agent performing the action in response to the observation.

Some reinforcement learning systems use a neural network to represent the value function. That is, the system uses a neural network that is configured to receive an observation and an action and to process the observation and the action to generate a value function estimate.

Some other reinforcement learning systems use a tabular representation of the value function. That is, the system maintains a table or other data structure that maps combinations of observations and actions to value function estimates for the observation-action combinations.

Constraints are inferred from expert entities and used for optimization of policies in current reinforcement learning pipelines. Said expert entities comply with one or more target constraints that are unknown to the reinforcement learning systems. However, there is no current technology that can achieve determination of said unknown target constraint in a suitable manner. Indeed, some technologies do not explicitly incorporate an agent identifier, and are thereby unable to differentiate between various agents based on their behavior. These technologies usually infer a single set of constraints assumed to be followed by all agents, which can result in low-quality constraints and suboptimal control performance. Some other technologies are more focused on recovering rewards than constraints, making it challenging to extend its application to constraint recovery. These technologies usually perform agent identification based on state-action pairs rather than full trajectories, which can render the learned constraints less reliable.

A system that may perform constraint inference for constraints adhered to by various expert entities using their expert demonstration datasets is thus desirable.

### SUMMARY

Developers have devised methods and devices for overcoming at least some drawbacks present in prior art solutions.

One aspect of the present technology is to provide a Multi-Modal-Inverse Constrained Reinforcement Learning (MMICRL) framework to infer different constraints for different types of agents. For example, in the autonomous driving environment, human drivers may follow different constraints, which are determined by their driving style (risk averse versus risk seeking) and different vehicles (size, acceleration, turning radius of motor cycles, cars and trucks). Different constraints lead to different trajectories in the dataset. For example, the safety constraint on the gap to the vehicle in front should be larger for a truck than a car. However, specifying the trajectories for all drivers and all vehicles with a single constraint may be a cumbersome task and inadequate.

In a first broad aspect of the present technology, there is provided a computer-implemented method for inferring constraints for reinforcement learning of an Artificial Intelligence (AI) model for subsequent deployment of that AI model in an environment. The method includes accessing a set of expert trajectories, each expert trajectory including a sequence of expert state-action pairs, a given one of the sequences of the expert state-action pairs including information about a given state of the environment and a corresponding action that is to be executed in response to the given state, partitioning the set of expert trajectories into one or more subsets of expert trajectories by employing a trained neural network, each subset being associated with one of the agents and determining, for each agent, an agent constraint based on the corresponding subset of expert trajectories.

In some non-limiting implementations, the method further includes accessing a set of policies, each policy including a sequence of state-action pairs, each state-action pair including information about a given state of the environment and a corresponding action to be executed in response to the environment being identified as being in said state, an execution of the policy aiming at maximizing a reward and adjusting one or more policies of the set of policies based on the one or more constraints for each of the associated agents.

In some non-limiting implementations, the trained neural network is configured to determine an agent based on an input including one or more expert trajectories.

In some non-limiting implementations, the agent is determined by, for each expert trajectory:

z_{E}=argmax_{z} p_{ψ}(τ^{E}|z)
where z_{E} is the agent, τ^{E} is the expert trajectory and p_{ψ} is a conditional flow-based estimation model.

In some non-limiting implementations, the trained neural network is trained to compute state-action density:

$${ρ}_{π} ( s , a ) = ( 1 - γ ) π ( a \vert s ) {\sum }_{t = 0}^{∞} {γ}^{t} p ( {s}_{t} = s \vert π )$$

where p(sₜ=s|π) is the probability density of state s at time step t following policy w.

In some non-limiting implementations, determining a constraint includes employing a permissibility function ϕ_{ω} such that:

$${𝔼}_{τ \sim π} [ {\prod }_{( s , a ) ∈ τ} {ϕ}_{ω} ( s , a ) ] \geq ϵ$$

where the permissibility function ϕ_{ω} is implemented as a neural network, ω maps parameters of the neural network and E is a pre-determined probability.

In some non-limiting implementations, adjusting a policy for a given agent includes determining an expert trajectory distribution π(τ|z), determining an agent identification likelihood

$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} ,$$

determining a cumulative reward [symbol] _{π(τ|z)}[Σₜ₌₀^{T}γ^{t}r(sₜ,aₜ)] and adjusting the policy based on a target objective expressed as:

$${Min}_{π} - {𝔼}_{π ( τ \vert z )} [ {\sum }_{t = 0}^{T} {γ}^{t} r ( {s}_{t} , {a}_{t} ) + {α}_{1} log [ {p}_{ψ} ( z \vert τ ) ] ] - ( {α}_{2} - {α}_{1} ) H [ π ( τ \vert z ) ]$$

$$s . t . , {𝔼}_{τ \sim π} ( τ \vert z ) [ {\prod }_{( s , a ) ∈ τ} {ϕ}_{ω} ( s , a ) ] \geq ϵ .$$

In some non-limiting implementations, adjusting one or more policies includes employing an adversarial training module.

In a second broad aspect of the present technology, there is provided a system for inferring constraints for reinforcement learning of an Artificial Intelligence (AI) model for subsequent deployment of that AI model in an environment. The system includes a controller and a memory storing a plurality of executable instructions which, when executed by the controller, cause the system to access a set of expert trajectories, each expert trajectory comprising a sequence of expert state-action pairs, a given one of the sequences of the expert state-action pairs including information about a given state of the environment and a corresponding action that is to be executed in response to the given state, partition the set of expert trajectories into one or more subsets of expert trajectories by employing a trained neural network, each subset being associated with one of the agents and determine, for each agent, an agent constraint based on the corresponding subset of expert trajectories.

In some non-limiting implementations, the system further accesses a set of policies, each policy comprising a sequence of state-action pairs, each state-action pair including information about a given state of the environment and a corresponding action to be executed in response to the environment being identified as being in said state, an execution of the policy aiming at maximizing a reward and adjusts one or more policies of the set of policies based on the one or more constraints for each of the associated agents.

In some non-limiting implementations, the trained neural network is configured to determine an agent based on an input comprising one or more expert trajectories.

In some non-limiting implementations, the agent is determined, for each expert trajectory, by:

z_{E}=argmax_{z} p_{ψ}(τ^{E}|z)
where z_{E} is the agent, τ^{E} is the expert trajectory and p_{φ} is a conditional flow-based estimation model.

In some non-limiting implementations, the trained neural network is trained to compute state-action density:

$${ρ}_{π} ( s , a ) = ( 1 - γ ) π ( a \vert s ) {\sum }_{t = 0}^{∞} {γ}^{t} p ( {s}_{t} = s \vert π )$$

where p(sₜ=s|π) is the probability density of state s at time step t following policy w.

In some non-limiting implementations, the system employs, upon determining a constraint, a permissibility function ϕ_{ω} such that:

$${𝔼}_{τ \sim π} [ {\prod }_{( s , a ) ∈ τ} {ϕ}_{ω} ( s , a ) ] \geq ϵ$$

where the permissibility function ϕ_{ω} is implemented as a neural network, ω maps parameters of the neural network and E is a pre-determined probability.

In some non-limiting implementations, the system determines, upon adjusting a policy for a given agent, an expert trajectory distribution π(τ|z), determines an agent identification likelihood

$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} ,$$

determines a cumulative reward [symbol] _{π(π/z)}[Σₜ₌₀^{T}γ^{t}r(sₜ,aₜ)] and adjusts the policy based on a target objective expressed as

$${Min}_{π} - {𝔼}_{π ( τ \vert z )} [ {\sum }_{t = 0}^{T} {γ}^{t} r ( {s}_{t} , {a}_{t} ) + {α}_{1} log [ {p}_{ψ} ( z \vert τ ) ] ] - ( {α}_{2} - {α}_{1} ) H [ π ( τ \vert z ) ]$$

$$s . t . , {𝔼}_{τ \sim π} ( τ \vert z ) [ {\prod }_{( s , a ) ∈ τ} {ϕ}_{ω} ( s , a ) ] \geq ϵ .$$

In some non-limiting implementations, the system employs an adversarial training module to adjust one or more policies.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of a computing environment for performing inverse constraint reinforcement learning in accordance with some implementations of the present technology;

FIG. 2 is a schematic representation of a pipeline for executing inverse constraint reinforcement learning in accordance with some implementations of the present technology;

FIG. 3 is a flow diagram of steps of a method for executing inverse constraint reinforcement learning for an Artificial Intelligence (AI) model for subsequent deployment of that AI model in an environment in accordance with some implementations of the present technology; and

FIG. 4 is a block diagram of a controller in accordance with some implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the reinforcement learning, a state (noted s) is a representation of a situation of the environment. A current state is thus a representation of the current situation of the environment. The agent may decide which action should be taken based on the state of the environment. It should be noted that the state can be partial or complete.

In the same context, actions (noted a) of the agent are the set of possible moves or decisions the agent can make to influence the environment. The agent selects actions to achieve a current goal.

In the same context, a policy (noted 7r) is a strategy or mapping from states to actions, defining how the agent decides what action to take for a given state of the environment. In other words, a policy is a strategy or a mapping that defines how an agent should behave in a given environment. It specifies the agent's decision-making process by determining which actions the agent should take in response to different states or situations. The goal of a policy is to maximize a cumulative reward the agent receives over time (i.e. over the execution of the actions the policy). In this context, a reward (noted R) is a numerical signal provided by the environment to evaluate the agent's actions. The agent's objective is to maximize the cumulative reward over time. A value function (noted V-function) is a function that estimates the expected cumulative reward that an agent can achieve starting from a particular state and following a specific policy. It helps the agent evaluate the desirability of different states of the environment. A Q-value function (noted Q-function) is similar to the value function but also takes into account the action taken in addition to the state of the environment. It estimates the expected cumulative reward for taking a specific action in a given state and following a policy.

A policy can be deterministic or stochastic. In a deterministic policy, for each possible state, there is a specific action that the agent should take. The policy thus directly maps states to actions. For example, if a robot is following a deterministic policy, it might have a rule that says “if the robot detects an obstacle in front of it, turn left.” In a stochastic policy, the selection of actions to be executed is determined by probabilities. The policy specifies the probability distribution over possible actions for each state. It can be said that a stochastic policy might allow for some randomness and exploration in the agent's behavior.

A policy thus guides the agent's decision-making process. Reinforcement learning algorithms aim to learn the most performing policy (e.g. maximized reward) for a given task. This can involve exploring different policies and evaluating their performance in terms of the cumulative rewards received. Once an optimal policy is found, the agent can use it to make decisions in the environment. For example, in a self-driving car application, the policy could determine when to accelerate, brake, or turn the steering wheel based on the current traffic conditions and the car's position. The policy is learned over time through interactions with the environment, and it adapts to changing conditions to ensure safe and efficient driving.

In summary, a policy in reinforcement learning is a strategy that specifies the agent's actions in response to states in the environment, and it plays a central role in helping the agent maximize the cumulative reward.

In the context of reinforcement learning, a trajectory is sequence of states, actions, and rewards experienced by an agent as it interacts with an environment, representing a specific path taken through the state-action space over a period of time

An expert trajectory, also known as an expert demonstration or expert data, refers to a sequence of state-action pairs that are provided by an “expert” entity (human or not) to demonstrate how a specific task or problem should be solved. These demonstrations are used to train or guide a reinforcement learning agent by providing examples of appropriate behavior or solutions to the problem.

Expert trajectories typically consist of the following components: a sequence of state-action pairs, a state s including a description of the environment's current situation or configuration, an action a taken by the expert entity when the environment is in state s to demonstrate the appropriate or desirable behavior.

Using expert trajectories may help in leveraging human expertise to initialize or guide the learning process of a reinforcement learning agent. By observing and learning from these expert demonstrations, the agent can better understand how to achieve the task or maximize the cumulative reward. Expert trajectories can be particularly useful in situations where defining a reward function or specifying an appropriate policy is challenging. By learning from expert-provided examples (e.g. human-provided examples), the agent can accelerate its learning process and, in some cases, achieve better performance more quickly. For example, in a game-playing scenario, an expert trajectory might consist of a recorded sequence of moves made by a skilled human player. The reinforcement learning agent can then learn from this trajectory to improve its own performance in the game.

Expert trajectories are often used in imitation learning, where the agent aims to mimic the behavior demonstrated by the expert. There are various algorithms and approaches, such as behavioral cloning and generative adversarial imitation learning (GAIL), that use expert trajectories to teach reinforcement learning agents to perform tasks effectively. In the context of the present disclosure, a mixture of expert trajectories refers to an offline data records trajectories generated by multiple types of expert entities respecting different constraints.

It should be noted that policies and expert trajectories serve different purposes in the context of reinforcement learning. A policy is a strategy used by a reinforcement learning agent to make decisions in an environment. It specifies how the agent selects actions based on states to maximize cumulative rewards. In reinforcement learning, the goal is often to learn an optimal policy through interactions with the environment and the use of reward signals. Policies guide the agent's decision-making process during learning and execution. In contrast, an expert trajectory, or expert demonstration, is a sequence of state-action pairs provided by a human or an expert to show how a specific task should be performed. Expert trajectories are typically not learned by the agent as they are provided by expert-entities as examples of how a task should be accomplished. Expert trajectories are used as training data to guide the learning process of the agent. The agent can learn from the demonstrated behavior in the trajectory and attempt to imitate it.

In the context of reinforcement learning, constraints are introduced to ensure that the agent's behavior adheres to certain rules or limits during the learning process. These constraints can be important in specific applications or scenarios where safety or specific behavior requirements are critical.

Different types of constraints may be defined. For example, safety constraints may be important in real-world applications to prevent the agent from taking actions that may lead to undesirable or dangerous situations. For example, in autonomous driving, constraints can be used to ensure that the vehicle doesn't violate traffic rules or cause accidents. As another example, task-specific constraints may also be defined with respect to natural constraints that should be followed. For instance, in a robotic assembly line, constraints can be applied to ensure that the robot assembles products correctly, following a pre-defined process. As yet another example, exploration constraints may be defined in exploration-heavy scenarios to limit the exploration space of the agent. This is done to focus learning on the most relevant states and actions. Constraints can help prevent the agent from taking excessive or risky exploration actions. As yet another example, soft constraints may be defined and used to guide the learning process without strictly enforcing them. These constraints can be used as penalties in the reward function to discourage the agent from taking certain actions or entering specific states, rather than outright prohibiting them.

Constraints are typically incorporated into the reinforcement learning framework through modifications to the reward function or by altering the optimization process. For example, constraints can be added to the reward function as penalties, or specialized constraint optimization methods can be used in combination with traditional reinforcement learning algorithms to ensure that the agent's policy complies with the desired constraints.

In reinforcement learning, the balance between achieving high rewards and adhering to constraints can be a challenging problem, particularly in applications where safety is paramount.

In the context of the present disclosure, Inverse Constraint Learning (ICL) refers to a problem-solving approach in which an agent learns to discover and infer the underlying constraints of a task by observing expert demonstrations, aiming to replicate the expert's behavior while satisfying the inferred constraints.

In the context of the present disclosure, constrained policy optimization refers to a reinforcement learning algorithm that optimizes a policy while enforcing specified constraints on the policy updates, ensuring stable and safe learning by limiting the divergence between the old and updated policies.

In the context of the present disclosure, agent identification refers to a process of inferring the type of an agent (e.g., a car or truck) by observing its actions and behavior within a given environment or context.

A Markov Decision Process (MDP) is a mathematical framework typically used for modeling decision-making problems in which an agent interacts with a stochastic environment to make sequential decisions, with the objective of maximizing a cumulative reward.

With these fundamentals in place, we will now consider some non-limiting examples to illustrate various implementations of aspects of the present technology.

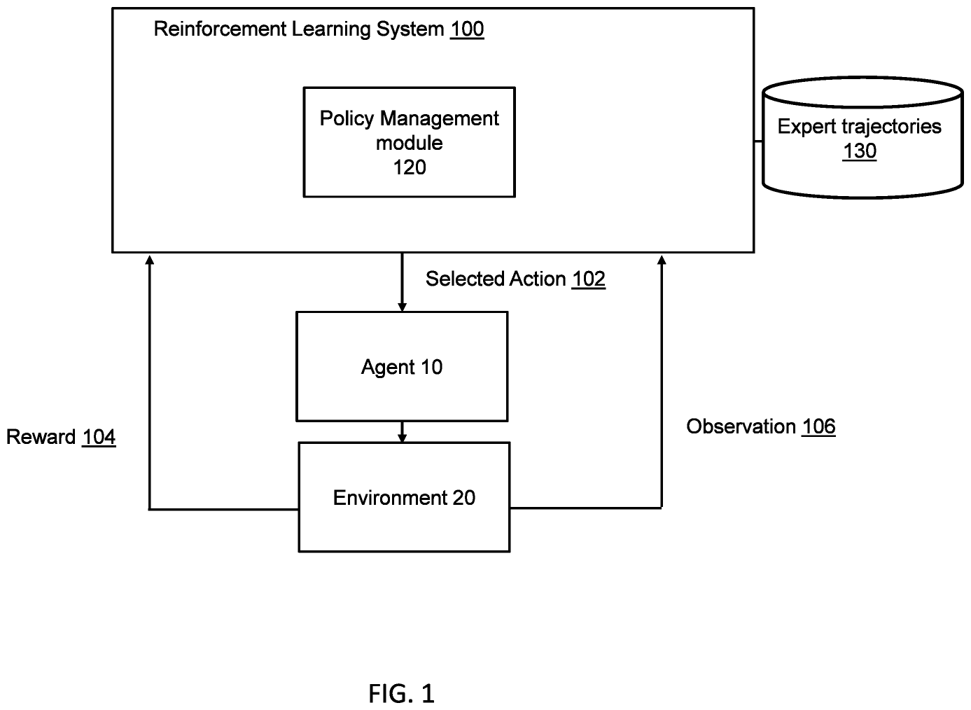

FIG. 1 shows an example reinforcement learning system 100. The reinforcement learning system 100 is an example of a system implemented as one or more computer programs on one or more computers in one or more locations in which the systems, components, and techniques described below are implemented. The reinforcement learning system 100 selects actions to be performed by an agent 10 that interacts with an environment 20. In particular, the reinforcement learning system 100 receives an observation 106 characterizing a current state of the environment 20 and uses a policy management module 120 to select an action 102 to be performed by the agent 10 while the environment is in the current state. In some implementations, the environment 20 may be a real-world environment. In some of these implementations, the reinforcement learning system 100 may be implemented as one or more computer programs on one or more computers embedded in a mechanical agent interacting with the environment 20. For example, the mechanical agent may be a semi- or fully-autonomous vehicle, watercraft, or aircraft or an underwater, on land, in the air, in space, or industrial robot. In some other implementations, the environment 20 may be a virtualized environment. The agent 10 may thus be a computer program that interacts with the virtualized environment 20. In some of these implementations, the reinforcement learning system 100 may be implemented as one or more computer programs on the same computer or computers as the agent.

As will be seen, teachings of the present disclosure may be applicable a variety of application fields such as, without limitation, autonomous driving, robotics and computer networks.

In use, the policy management module 120 uses a value function representation that estimates the return resulting from the agent performing specific actions when the environment 20 is in a given state. In some implementations, the value function representation is a machine learning model, e.g., a deep neural network, that is configured to receive as input a state representation for an environment state and an action from the set of actions and to output a value function estimate for the state-action pair. The value function estimate for a state-action pair is an estimate of the return resulting from the agent performing the input action in response to an observation characterizing the given state of the environment 20.

Generally, the reinforcement learning system 100 derives a state representation for a given state from the received observation 106 that characterizes the given state. In some implementations, the state representation for a given state is the observation received by the reinforcement learning system 100 that characterizes the given state. In some other implementations, the value function representation may be a recurrent neural network that maintains an internal state and updates the internal state using each received observation 106. In yet other implementations, the reinforcement learning system 100 may combine the current observation with one or more recent observations to generate the state representation for the current state of the environment 20.

In some implementations, the value function estimate may be associated with a reliability score representative of an accuracy of the value function estimate in estimating the return resulting from the agent performing specific actions in response to a given observation. The reliability score may be determined using a machine learning model, e.g., a deep neural network, that is configured to receive as input a state representation and an action from the set of actions and to output a reliability score that is a measure of the accuracy with which the value function estimate generated in accordance with the value function representation describes the return resulting from the agent performing the input action in response to the received observation 106.

The reinforcement learning system 100 uses the policy management module 120 to select the action 102 to be performed by the agent 10 in response to the observation 106 by determining, for each action in the set of actions, a respective value function estimate in accordance with the value function representation and a respective reliability score. The reinforcement learning system 100 then adjusts the respective value function estimate for the action using the reliability score for the action and uses the adjusted value function estimate to select the action 102 to be performed by the agent 10.

Once the agent 10 has performed the selected action 102, the reinforcement learning system 100 identifies a reward 104 resulting from the agent 10 performing the selected action 102 in the environment 20. The reward 104 is an immediate actual reward resulting from the agent 10 performing the selected action 102 in response to the observation 102. The reinforcement learning system 100 may use the reward 104 to update the value function representation. The reinforcement learning system 100 may also then update the manner through which the reliability score is determined to reflect the change in the measure of accuracy in the value function estimates resulting from the agent 10 having performed the selected action 102 in response to the observation 102.

The reinforcement learning system 100 may also access expert trajectories stored in an expert trajectory database 130 communicably connected to the reinforcement learning system 100. How communication links between the reinforcement learning system 100 and the agent 10, the environment 20 and the expert trajectory database 130 are implemented will depend inter alia on how the reinforcement learning system 100 and the agent 10, the environment 20 and the expert trajectory database 130 are implemented.

In the context of the present disclosure, a goal of a constraint is to ensure some notion of safety or that some guarantees are achieved with respect to the agent 10 executing actions in the environment 20. When constraints are learnt by the reinforcement learning system 100, there is some uncertainty about the resulting constraints. The resulting constraints may be more or less constraining than the unknown target constraint. When the learnt constraint is less constraining than the unknown target constraint, a policy optimized based thereon may compromise safety and may fail to provide desirable guarantees. It may thus be desirable to allow selection of a confidence level based on which constraints are inferred.

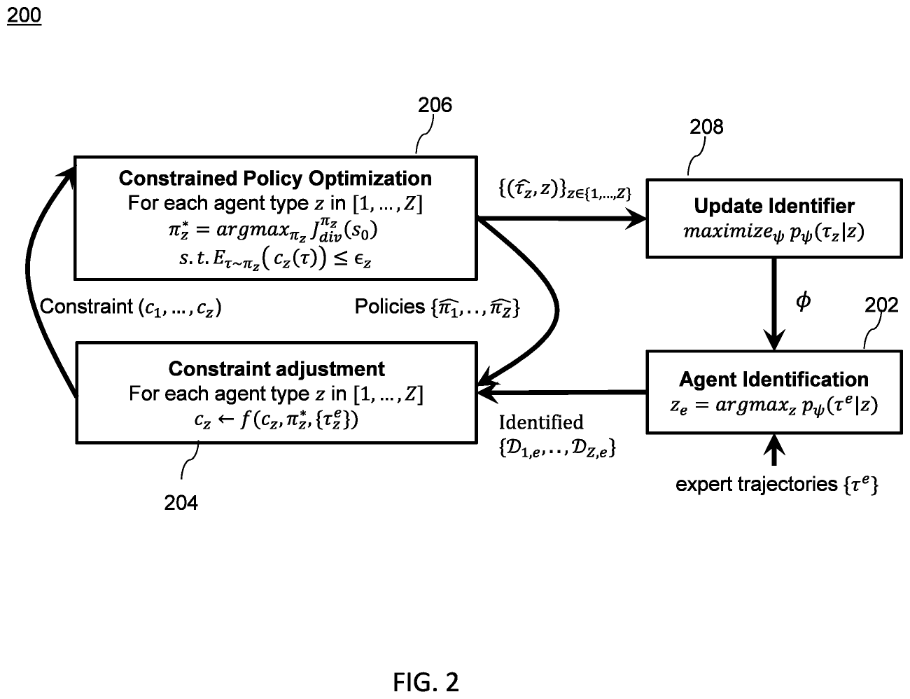

FIG. 2 is a diagram of a pipeline 200 for executing inverse constraint reinforcement learning in accordance with some implementations of the present technology.

At block 202, the reinforcement learning system 100 performs an entity identification process for a received set of expert trajectories {τ^{e}}. In this implementation, the reinforcement learning system 100 accesses a set of policies and defines a state-action density:
ρ_{π}(s,a)=(1−y)π(a|s)Σₜ₌₀^{∞}γ^{t} p(sₜ=s|π), where p(sₜ=s|π) is the probability density of state s at time step t following policy w.

To do so, the reinforcement learning system 100 executes a trained Conditional Flow-based Density Estimator (CFDE) to fit the state-action distribution from different expert entities. The reinforcement learning system 100. The reinforcement learning system 100 further determines an entity for each expert trajectory by determining:

zₑ=argmax_{z} p_{ψ}(τ^{e}|z)
where a softmax representation of the corresponding entity is

$${p}_{ψ} ( z \vert τ ) = \frac{exp {\sum }_{( s , a ) ∈ {τ}_{E}} log [ {p}_{ψ} ( s , a \vert z ) ]}{{\sum }_{z} exp {\sum }_{( s , a ) ∈ {τ}_{E}} log [ {p}_{ψ} ( s , a \vert z ) ]} .$$

The reinforcement learning system 100 forms subsets of expert trajectories from the set {τ^{e}}. More specifically, each subset is initialized as being empty.

In some implementations, the number of subsets Z is pre-determined and known by the reinforcement learning system 100. In some other implementations, the reinforcement learning system 100 in configured to infer the number of subsets Z. For example in these implementations, the reinforcement learning system 100 may perform cross-validation routines with different numbers of subsets and select the number Z based on pre-determined metrics such as accuracy of the partitioned subset and/or a computing latency. For each subset D_{z}, a given expert trajectory τ_{E} is added to the subset Dᵢ in response to z=argmax_{z} p_{ψ}(z|τ_{E}). Therefore, each subset Dᵢ includes expert trajectories from the set {τ^{e}} that correspond to a same expert entity z. The number of expert entity inferred by the reinforcement learning system 100 is thus equal to a number of subsets formed.

In use, an expert trajectory τ^{E}=(s₀, a₀, s₁, a₁, . . . , sₙ, aₙ) may thus be accessed by the reinforcement learning system 100. For example, in the application of autonomous driving, s includes position and velocity of ego car and surrounding cars, a includes steering and acceleration. The reinforcement learning system 100 may further identify the expert entity with the density model z_{E}=argmax_{z} p_{ψ}(τ^{E}|z).

At block 204, the reinforcement learning system 100 infers, for each expert entity z, a conditional constraint function c_{z}(x) from the dataset D_{z} and π(·|z). In some implementations, the constraint are inferred by employing a permissibility function ϕ_{ω} such that: [symbol] _{τ˜π}[Π_{(s,a)∈τ}(s,a)]≥ε where ε is a pre-determined threshold.

As will be described in greater details herein after, the constraint functions ϕ_{ω}(s,a) are inferred by optimizing the log-likelihood of the expert trajectories. In this implementation, a single constraint is inferred per expert entity (i.e. per subset of expert trajectories). ε is a hyperparameter that is set by a domain expert to determine how soft the constraint should be. More specifically, ε=1 yields a constraint where every trajectory is feasible. ε<1 yields a constraint where E is the probability with which a trajectory should be feasible.

In this implementation, ϕ is, in use, implemented as a neural network that returns the probability that a state-action pair is permitted. For example, the neural network may be configured to provide a sigmoid output. ω denotes the parameters of said neural network.

At block 206, the reinforcement learning system 100 executes a policy optimization process based on the inferred constraint functions. In order to optimize a policy by utilizing an inferred constraint, the reinforcement learning system 100 estimates, in this implementation, an action-specific policy entropy [symbol] [π(τ|z)]. The reinforcement learning system 100 further determines an entity agent identification likelihood

$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} .$$

The reinforcement learning system 100 further determines a cumulative reward: [symbol] _{π(τ|z)}[Σₜ₌₀^{T}γ^{t}r(sₜ,aₜ)].

The reinforcement learning system 100 finally update the policy with the following objective:

$${Min}_{π} - {𝔼}_{π ( τ \vert z )} [ {\sum }_{t = 0}^{T} {γ}^{t} r ( {s}_{t} , {a}_{t} ) + {α}_{1} log [ {p}_{ψ} ( z \vert τ ) ] ] - ( {α}_{2} - {α}_{1} ) ℋ [ π ( τ \vert z ) ] \\ s . t . , {𝔼}_{τ \sim π} ( τ \vert z ) [ {\prod }_{( s , a ) ∈ τ} {ϕ}_{ω} ( s , a ) ] \geq ϵ$$

In some implementation, an objective of the optimization is defined as a multi-modal policy optimization objective:

$${max}_{θ} {E}_{τ \sim {π}_{θ} ( \cdot \vert Z )} [ r ( τ ) ] + {α}_{1} H [ π ( τ ) ] - {α}_{2} H [ π ( τ \vert z ) ] s . t . {E}_{τ \sim {π}_{θ} ( \cdot \vert z )} ( {c}_{z} ( τ ) ) \leq {ϵ}_{z}$$

where H[π(τ)]=H[π(τ|z)]+E_{τ˜π}_{_{θ}}(·|z)(log[p(z|T)])+H[p(z))]. It should be noted that these two objectives are mathematically equivalent.

The developers of the present technology have realized that said objective may help the entity to generate the trajectories with a large density. The optimized policies may further be used for constraint adjustments in block 204.

At block 208, optimized trajectories {( [symbol] ,z)}_{z∈{1, . . . , z}} are determined based on the optimized policies for each expert entity and update the entity identifier. In this implementation, the probability densities p_{ψ}(τ_{z}|z) are maximized along function ψ based on the optimized trajectories, where ψ denotes the parameters of the density function. In other words, the probability density of trajectories for each expert p_{ψ}(τ_{z}|z) is re-optimized at block 208 by taking the trajectories in the cluster associated with an expert and maximizing the likelihood of those trajectories.

More specifically, the functions ϕ may be referred to as permissibility function ϕ_{ω}(s,a|z). A given permissibility function may be parameterized by the reinforcement learning system 100 by employing a neural network which indicates the probability that a state-action pair is permitted for an agent z. In use, the trajectories \hat{τ}=(ŝ₀, â₀, . . . , ŝ_{T}, â_{T}) are sampled by executing optimized policy \hat{π}. The reinforcement learning system 100 further updates the parameters of the permissibility function ϕ_{ω}(s,a|z) by computing the gradient of the likelihood function:

$${\sum }_{i = 1}^{N} [ {∇}_{ϕ} {\sum }_{t}^{T} η log [ {ϕ}_{ω} ( {s}_{t}^{( i )} , {a}_{t}^{( i )} \vert z ) ] ] - N {𝔼}_{\hat{τ} \sim \hat{π}} [ {∇}_{ϕ} {\sum }_{t}^{T} η log [ {ϕ}_{ω} ( , \vert z ) ] ]$$

where N is the number of expert trajectories and T is the planning horizon (i.e., length of the expert trajectories).

Therefore, the reinforcement learning module 100 may identify the agent who generates a trajectory by examining its density without relying on any supervising label. In addition, the reinforcement learning module 100 may estimate different constraints for different expert entities.

The reinforcement learning module 100 may also learn different policies for different types of expert entities according to the learned constraints. It should be noted that the policy gradient objective may facilitate a provision for a relatively wide range of trajectories generated by different expert entities. Users of the reinforcement learning module 100 may thus choose one of the constraints to optimize the policy of the corresponding type of entity.

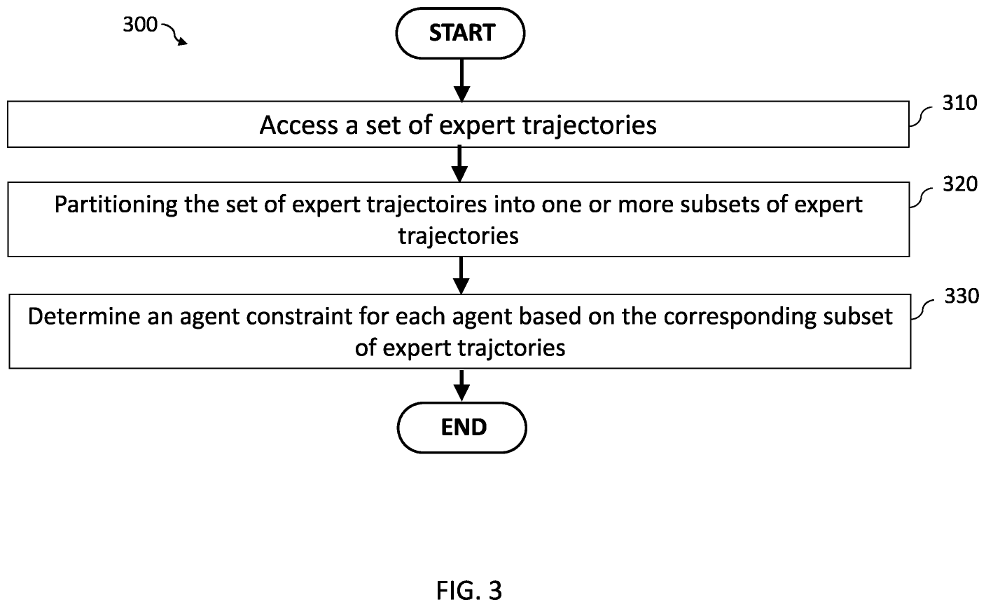

FIG. 3 a flow diagram of a method 300 for inferring constraints for reinforcement learning of an Artificial Intelligence (AI) model for subsequent deployment of that AI model in an environment according to some implementations of the present technology. In one or more aspects, the method 300 or one or more steps thereof may be performed by a processor or a computer system, such as the reinforcement learning system 100. The method 300 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

Broadly speaking, the method includes inference of a density model to classify the expert trajectories according to their types of expert entity, inference of different constraints for different types of expert entities, and inference of different policies for different types of experts in order to imitate the expert trajectories. Therefore, the disclosed method may be used, for example and without limitation, in the field of design of autonomous driving systems, where different entity types of agents (i.e., large car, small car, truck or motor bike) and corresponding agent constraint may be inferred. The method may thus allow for inference of different constraints for different types of agents and enable an agent such as agent 10 to perform safe control by utilizing these constraints.

The method 300 starts with accessing, at operation 310, a set of expert trajectories. Each expert trajectory includes a sequence of expert state-action pairs, a given one of the sequences of the expert state-action pairs including information about a given state of the environment and a corresponding action that is to be executed in response to the given state.

The method 300 continues with partitioning, at operation 320, the set of expert trajectories into one or more subsets of expert trajectories, each subset being associated with one of the agents.

In this implementation, a trained neural network is employed to perform the partition.

The method 300 continues with determining, at operation 320 and for each agent, an agent constraint based on the corresponding subset of expert trajectories. In some implementations, the agent constraint may be determined by employing a permissibility function ϕ_{ω} such that [symbol] _{τ˜} [Π_{(s,a)∈τ}ϕ_{ω}(s,a)]≥ε where the permissibility function ϕ_{ω} is implemented as a neural network, ω maps parameters of the neural network and E is a pre-determined probability.

In some implementations, the method 300 continues with accessing a set of policies, each policy comprising a sequence of state-action pairs, each state-action pair including information about a given state of the environment and a corresponding action to be executed in response to the environment being identified as being in said state, an execution of the policy aiming at maximizing a reward. The method 300 may further include adjusting one or more policies of the set of policies based on the one or more constraints for each of the associated agents.

In some implementations, the policy is adjusted for a given agent by determining an expert trajectory distribution π(τ|z), determining an agent identification likelihood

$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} ,$$

determining a cumulative reward [symbol] _{π(τ|z)} [Σₜ₌₀^{T}γ^{t}r(sₜ,aₜ)] and adjusting the policy based on a target objective expressed as:

$${Min}_{π} - {𝔼}_{π ( τ \vert z )} [ {\sum }_{t = 0}^{T} {γ}^{t} r ( {s}_{t} , {a}_{t} ) + {α}_{1} log [ {p}_{ψ} ( z \vert τ ) ] ] - ( {α}_{2} - {α}_{1} ) ℋ [ π ( τ \vert z ) ] \\ s . t . , {𝔼}_{τ \sim π} ( τ \vert z ) [ {\prod }_{( s , a ) ∈ τ} {ϕ}_{ω} ( s , a ) ] \geq ϵ .$$

In the same or other implementations, the one or more policies may be adjusted by employing an adversarial training module.

In some implementations, the trained neural network determines an agent based on an input comprising one or more expert trajectories. For example and without limitations, the agent is determined by, for each expert trajectory, determining z_{E}=argmax_{z} p_{ψ}(τ^{E}|z) where z_{E} is the agent, τ^{E} is the expert trajectory and p_{ψ} is a conditional flow-based estimation model.

In the same implementations, the trained neural network may be trained to compute state-action density: ρ_{π}(s,a)=(1−γ)π(a|s)Σₜ₌₀^{∞}γ^{t} p(sₜ=s|π) where p(sₜ=s|π) is the probability density of state s at time step t following policy π.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It can thus be said that the disclosed methods allow the inference of constraints from the demonstration data generated by different types of expert entities.

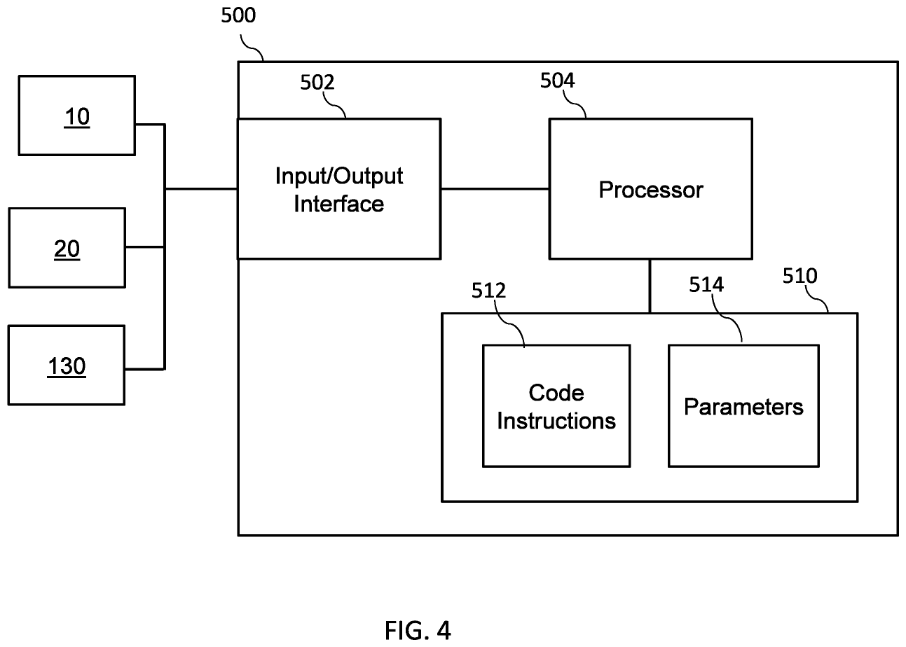

As an example, FIG. 4 is a schematic block diagram of a controller 500 for executing the method 800 according to an implementation of the present technology. The reinforcement learning system 100 may be implemented as the controller 500. The controller 500 comprises a processor or a plurality of cooperating processors (represented as a processor 504 for simplicity), a memory device or a plurality of memory devices (represented as a memory device 510 for simplicity), and a input/output interface 502 allowing the controller 500 to communicate with other components of the reinforcement learning system 100 and/or other components in remote communication with the reinforcement learning system 100 such as the expert trajectory database 130. The processor 504 is operatively connected to the memory device 510 and to the input/output interface 502. The memory device 510 includes a storage for storing parameters 514, including for example and without limitation the above-mentioned expert trajectories. The memory device 510 may also comprise a non-transitory computer-readable medium for storing code instructions 512 that are executable by the processor 504 to allow the controller 500 to perform the various tasks allocated to the controller 500 in the methods disclosed herein.

The controller 500 is operatively connected, via the input/output interface 502, to the agent 10, the environment 20 and the expert trajectory database 30. The controller 500 executes the code instructions 512 stored in the memory device 510 to implement the various above-described functions that may be present in a particular implementation. FIG. 4 as illustrated represents a non-limiting implementation in which the controller 500 orchestrates operations of the labelling module 100. This particular implementation is not meant to limit the present disclosure and is provided for illustration purposes.

It should be expressly understood that not all technical effects mentioned herein need to be enjoyed in each and every implementation of the present technology. Modifications and improvements to the above-described implementations of the present technology may become apparent to those skilled in the art. The foregoing description is intended to be exemplary rather than limiting. The scope of the present technology is therefore intended to be limited solely by the scope of the appended claims.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for inferring constraints for reinforcement learning of an Artificial Intelligence (AI) model for subsequent deployment of that AI model in an environment, the method comprising:
accessing a set of expert trajectories, each expert trajectory comprising a sequence of expert state-action pairs, a given one of the sequences of the expert state-action pairs including information about a given state of the environment and a corresponding action that is to be executed in response to the given state;
partitioning the set of expert trajectories into one or more subsets of expert trajectories by employing a trained neural network, each subset being associated with one of the agents; and
determining, for each agent, an agent constraint based on the corresponding subset of expert trajectories.

2. The method of claim 1, further comprising:
accessing a set of policies, each policy comprising a sequence of state-action pairs, each state-action pair including information about a given state of the environment and a corresponding action to be executed in response to the environment being identified as being in said state, an execution of the policy aiming at maximizing a reward; and
adjusting one or more policies of the set of policies based on the one or more constraints for each of the associated agents.

3. The method of claim 1, wherein the trained neural network is configured to determine an agent based on an input comprising one or more expert trajectories.

4. The method of claim 3, wherein, for each expert trajectory, the agent is determined by:
z_{E}=argmax_{z} p_{ψ}(τ^{E}|z)
where z_{E} is the agent, τ^{E} is the expert trajectory and p_{ψ} is a conditional flow-based estimation model.

5. The method of claim 4, wherein the trained neural network is trained to compute state-action density:
$${ρ}_{π} ( s , a ) = ( 1 - γ ) π ( a \vert s ) {\sum }_{t = 0}^{∞} {γ}^{t} p ( {s}_{t} = s \vert π )$$
where p(sₜ=s|π) is the probability density of state s at time step t following policy π.

6. The method of claim 1, wherein determining a constraint comprises employing a permissibility function ϕ_{ω} such that:
$${𝔼}_{τ \sim π} [ {\prod }_{( s , a ) ∈ τ} {ϕ}_{ω} ( s , a ) ] \geq ϵ$$
where the permissibility function ϕ_{ω} is implemented as a neural network, ω maps parameters of the neural network and ε is a pre-determined probability.

7. The method of claim 1, wherein adjusting a policy for a given agent comprises:
determining an expert trajectory distribution π(τ|z);
determining an agent identification likelihood
$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} ;$$
determining a cumulative reward [symbol] _{π(τ|z)}[Σₜ₌₀^{T}γ^{t}r(sₜ,aₜ)]; and
adjusting the policy based on a target objective expressed as:
$${Min}_{π} - {𝔼}_{π ( τ \vert z )} [ {\sum }_{t = 0}^{T} {γ}^{t} r ( {s}_{t} , {a}_{t} ) + {a}_{1} log [ {p}_{ψ} ( z \vert τ ) ] ] - ( {α}_{2} - {α}_{1} ) ℋ [ π ( τ \vert z ) ] \\ s . t . , {𝔼}_{τ \sim π ( τ \vert z )} [ {\prod }_{( s , a ) ∈ τ} {ϕ}_{ω} ( s , a ) ] \geq ϵ .$$

8. The method of claim 1, wherein adjusting one or more policies comprises employing an adversarial training module.

9. A system for inferring constraints for reinforcement learning of an Artificial Intelligence (AI) model for subsequent deployment of that AI model in an environment, the system comprising a controller and a memory storing a plurality of executable instructions which, when executed by the controller, cause the system to:
access a set of expert trajectories, each expert trajectory comprising a sequence of expert state-action pairs, a given one of the sequences of the expert state-action pairs including information about a given state of the environment and a corresponding action that is to be executed in response to the given state;
partition the set of expert trajectories into one or more subsets of expert trajectories by employing a trained neural network, each subset being associated with one of the agents; and
determine, for each agent, an agent constraint based on the corresponding subset of expert trajectories.

10. The system of claim 9, further configured to:
access a set of policies, each policy comprising a sequence of state-action pairs, each state-action pair including information about a given state of the environment and a corresponding action to be executed in response to the environment being identified as being in said state, an execution of the policy aiming at maximizing a reward; and
adjust one or more policies of the set of policies based on the one or more constraints for each of the associated agents.

11. The system of claim 9, wherein the trained neural network is configured to determine an agent based on an input comprising one or more expert trajectories.

12. The system of claim 11, wherein, for each expert trajectory, the agent is determined by:
z_{E}=argmax_{z} p_{ψ}(τ^{E}|z)
where z_{E} is the agent, τ^{E} is the expert trajectory and p_{ψ} is a conditional flow-based estimation model.

13. The system of claim 12, wherein the trained neural network is trained to compute state-action density:
$${ρ}_{π} ( s , a ) = ( 1 - γ ) π ( a \vert s ) {\sum }_{t = 0}^{∞} {γ}^{t} p ( {s}_{t} = s \vert π )$$
where p(sₜ=s|π) is the probability density of state s at time step t following policy π.

14. The system of claim 9, wherein the system is, upon determining a constraint, configured to employ a permissibility function ϕ_{ω} such that:
$${𝔼}_{τ \sim π} [ {\prod }_{( s , a ) ∈ τ} {ϕ}_{ω} ( s , a ) ] \geq ϵ$$
where the permissibility function ϕ_{ω} is implemented as a neural network, ω maps parameters of the neural network and ε is a pre-determined probability.

15. The system of claim 9, wherein the system is configured to, upon adjusting a policy for a given agent:
determine an expert trajectory distribution π(τ|z);
determine an agent identification likelihood
$${p}_{ψ} ( z \vert τ ) = \frac{{\prod }_{( s , a ) ∈ τ} {p}_{ψ} ( s , a \vert z )}{{\sum }_{{z}^{′}} exp {\prod }_{( s , a ) ∈ τ} {p}_{ψ} ( s , a \vert {z}^{′} )} ;$$
determine a cumulative reward [symbol] _{π(τ|z)}[Σₜ₌₀^{T}γ^{t}r(sₜ,aₜ)]; and
adjust the policy based on a target objective expressed as:
$${Min}_{π} - {𝔼}_{π ( τ \vert z )} [ {\sum }_{t = 0}^{T} {γ}^{t} r ( {s}_{t} , {a}_{t} ) + {α}_{1} log [ {p}_{ψ} ( z \vert τ ) ] ] - ( {α}_{2} - {α}_{1} ) ℋ [ π ( τ \vert z ) ] \\ s . t . , {𝔼}_{τ \sim π ( τ \vert z )} [ {\prod }_{( s , a ) ∈ τ} {ϕ}_{ω} ( s , a ) ] \geq ϵ .$$

16. The system of claim 9, wherein the system is further configured to employ an adversarial training module to adjust one or more policies.
